(19) United States
(12) Patent Application Publication
(10) Pub. No.: US 2009/0087771 A1
(43) Pub. Date: Apr. 2, 2009

(54) ELECTROPHOTOGRAPHIC CARRIER

(75) Inventors: Hidemasa SAWADA, Tokyo (JP); Kenji YAMANE, Kanagawa (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 12/196,729

(22) Filed: Aug. 22, 2008

(30) Foreign Application Priority Data
Sep. 27, 2007 (JP) 2007250930

(51) Int. Cl. G03G 9/083

(52) U.S. Cl. 430/110.2; 430/111.35

(57) ABSTRACT

An objective is to provide an electrophotographic carrier as a resin coating type carrier containing a conductive particle in a resin coating layer, which inhibits an edge effect via appropriately sufficient action as a developing electrode for a long duration, and acquires high fine line reproduction. Disclosed is an electrophotographic carrier possessing a surface of a magnetic material particle and provided thereon a resin coating layer containing a conductive particle, wherein a cross section of the resin coating layer, photographed with a transmission electron microscope has an average porosity ratio of 1-20%, and further disclosed is the electrophotographic carrier, wherein the resin coating layer comprises an acrylic resin.

### TECHNICAL FIELD

The present invention relates to an electrophotographic carrier of a double component developing agent, utilized for image formation with an electrophotographic method, for example

### BACKGROUND

In the past, conventionally employed has been a method in which an electrostatic latent image is formed on a photoreceptor or an electrostatic recording body employing each of various devices, and toner particles are attached onto this electrostatic latent image to develop the electrostatic latent image. During this development, a carrier particles called carriers are mixed with toner particles, and an appropriate amount of positive or negative charge is provided to toner particles by generating frictional electrification in both of them to each other. The carriers are roughly divided into a resin coating type carrier in which a resin is coated on the surface, and a resin uncoated carrier in which no resin coating layer is provided on the surface, but the various resin coating type carriers have been developed and put into practical use, since there is an advantage that a developing agent formed from the resin coating type carrier exhibits long life.

However, the resin coating type carrier can not act sufficiently as a developing electrode since electrical resistivity becomes large in the presence of a resin forming a resin coating layer, whereby image density in a central portion is expressed weak, and image density in an end portion is expressed dense when a large size image is formed, that is, an image sharply affected by an edge effect results. Further, there appears a drawback such that an image having extremely low reproduction is produced when the image to be formed is a halftone image. Further, there also appears a problem such as low fine line reproduction.

In order to solve the above-described problems, proposed are a technique in which a conductive layer containing carbon black is further formed on an upper layer of a resin coating layer (refer to Patent Document 1, for example), and a technique in which a conductive particle containing metal oxide such as carbon black (refer to Patent Document 2, for example), tin oxide, titanium oxide, zinc oxide, or the like (refer to Patent Document 3, for example) is dispersed in a resin coating layer.

However, there is a problem such that when a large amount of conductive particles is added to lower electrical resistivity of the resin coating type carrier, the resulting carrier results in low charge providing capability, whereby a charging amount of toner is lowered, and as a result, the carrier can not be used for a long duration.

(Patent Document 1) Japanese Patent O.P.I. Publication No. 2005-345676

(Patent Document 2) Japanese Patent O.P.I. Publication No. 56-126843

(Patent Document 3) Japanese Patent O.P.I. Publication No. 64-35561

### SUMMARY

The present invention has been made on the basis of the above-described situation, and it is an object of the present invention to provide an electrophotographic carrier as a resin coating type carrier containing a conductive particle in a resin coating layer, which inhibits an edge effect via appropriately sufficient action as a developing electrode for a long duration, and acquires high fine line reproduction.

### BRIEF DESCRIPTION OF THE DRAWINGS

Embodiments will now be described, by way of example only, with reference to the accompanying drawings which are meant to be exemplary, not limiting, and wherein like elements numbered alike in several figures, in which:

FIG. 1 is an illustration diagram showing an example concerning an cross section of a resin coating layer of an, electrophotographic carrier in the present invention;

FIG. 2 is an illustration diagram showing another example concerning an cross section of a resin coating layer of an electrophotographic carrier in the present invention;

FIG. 3 is an illustration diagram showing an example concerning an cross section of a resin coating layer of an electrophotographic carrier possessing no porosity; and

FIG. 4 is a schematic diagram showing a structural example of an image forming apparatus in which a developer formed from a carrier of the present invention is employed.

### DETAILED DESCRIPTION OF THE INVENTION

Next, the present invention will be specifically described.

### [Electrophotographic Carrier]

An electrophotographic carrier of the present invention (hereinafter, referred to simply as “carrier”) comprises a surface of a magnetic material particle and provided thereon a resin coating layer comprising a conductive particle, and a cross section of the resin coating layer, photographed with a transmission electron microscope, has an average porosity ratio of 1-20%, but preferably has an average porosity ratio of 1-5%. The average porosity ratio is designated as a measure indicating a presence ratio of portions other than portions formed from a solid component or a liquid component such as a resin, an additive and so forth which are present in the resin coating layer of the carrier, that is to say, holes and air bubbles.

In the case of an average porosity ratio of a resin coating layer being in the range of 1-20%, charge providing performance to toner is obtained by designing low resistivity of carrier, and film-peeling caused by frictional stress is difficult to be produced. In the case of an average porosity ratio of the resin coating layer being less than 1%, there is a problem such that the charge providing performance is low with designing of low resistivity since a large amount of conductive particles are added to form conductive paths, though film-peeling of the resin coating layer caused by frictional stress is difficult to be produced because of high mechanical strength of the resin coating layer since the resin coating layer is filled with a solid component and a liquid component such as a resin, additives and so forth. On the other hand, in the case of an average porosity ratio of the resin coating layer exceeding 20%, film-peeling of the resin coating layer is easy to be produced because of low mechanical strength of the resin coating layer, though conductive paths are formed with a small amount of conductive particles, and good charge providing performance to toner is obtained with designing of low resistivity of carrier.

### [Measuring Method of Average Porosity Ratio]

The average porosity ratio of a resin coating layer constituting a carrier of the present invention is a value determined by the following method. That is, a thin specimen of the carrier particle was prepared employing a focused ion beam specimen preparation system (SM12050, manufactured by STT NanoTechnology Inc.), and the cross-section of the thin specimen was subsequently observed at a magnification of 5000 times employing a transmission electron microscope (JEM-2010F, manufactured by JEOL Ltd.) to introduce the micrograph into a scanner. Then, porosity portions in the resin coating layer are processed via binarization employing an image processing analyzer (LUZEX AP, manufactured by Nireco Corporation) to calculate an area ratio of porosity in the resin coating layer within the image plane visual field. After conducting the foregoing operation for 100 carrier particles, an obtained mean value thereof is designated as the average porosity ratio.

### [Conductive Particle]

The conductive particle contained in a resin coating layer constituting a carrier of the present invention preferably contains at least one of carbon black, zinc oxide and tin oxide. Particles each made of carbon black are preferable as the conductive particle since an effect (filler effect) to improve resin strength results, and the resulting developer exhibits high durability. It is preferable that an addition amount of the conductive particle in the resin coating layer is 2-40 parts by weight, with respect to 100 parts by weight of a resin constituting the resin coating layer, for example, provided that the conductive particle consists of carbon black; 2-150 parts by weight, with respect to 100 parts by weight of a resin constituting the resin coating layer, for example, provided that the conductive particle consists of zinc oxide; and 2-200 parts by weight, with respect to 100 parts by weight of a resin constituting the resin coating layer, for example, provided that the conductive particle consists of tin oxide.

The conductive particle preferably has a number average primary particle diameter of 5-150 nm. In addition, the number average primary particle diameter does not represent a particle diameter of a coagulated secondary particle, but a particle diameter of a single conductive particle.

The number average primary particle diameter of the conductive particle is a value determined by the following method. That is, a thin specimen of the carrier particle was prepared employing a focused ion beam specimen preparation system (SM12050, manufactured by SII NanoTechnology Inc.), and the cross-section of the thin specimen was subsequently observed at a magnification of 5,000,000 times employing a transmission electron microscope (JEM-2010F, manufactured by JEOL Ltd.) to introduce the micrograph into a scanner. Then, a number average primary particle diameter of the conductive particle was measured in horizontal Feret diameter “FERE H” employing an image processing analyzer (LUZEX AP, manufactured by Nireco Corporation). The measurement number of the conductive particle is set to 50, and when one micrograph view field is not good enough, the number of view fields is increased up to 50 for the measurement number. The mean value of 50 thereof is designated as a number average primary particle diameter of the conductive particle.

### [Resin Coating Layer]

Examples of the resin preferable as a resin constituting a resin coating layer for a carrier of the present invention include polyolefin based resins such as polyethylene, polypropylene, chlorinated polyethylene, chlorosulfonated polyethylene and so forth; polyvinyl based or polyvinylidene based resins such as polyacrylate like polystyrene or polymethylmethacrylate, polyacrylonitrile, polyvinyl acetate, polyvinyl alcohol, polyvinyl butyral, polyvinyl chloride, polyvinyl carbazole, polyvinyl ether, polyvinylidene ketone and so forth; copolymers such as a vinyl chloride-vinyl acetate copolymer, a styrene-acrylic acid copolymer and so forth; a silicone resin formed via organosiloxane bonding, or for example, a modified resin formed from an alkyd resin, a polyester resin, an epoxy resin or a polyurethane resin; fluorine resins such as polyvinyl fluoride, polyvinylidene fluoride, polychlorotrifluoro ethylene and so forth; polyamide; polyester; polyurethane; polycarbonate; amino resins such as a ureaformaldehyde resin and so forth; and epoxy resins. Of these, an acrylic resin is specifically preferable as the resin constituting the resin coating layer. In addition, as the acrylic resin, provided are polymers and copolymers of an acrylic acid and its ester, acrylamide, acrylonitrile, a methacrylic acid and its ester, and so forth. Specific examples thereof include a polyacrylic acid, a polymethacrylic acid, polymethyl acrylate, polymethyl methacrylate, polycyclohexyl methacrylate and so forth. A resin constituting the resin coating layer may contain a resin other than the acrylic resin as a main component.

A resin constituting the resin coating layer preferably has a glass transition temperature Tg of 110-180° C.

The resin coating layer preferably has an average thickness h of 50-4000 nm in view of compatibility between durability of carrier and low resistivity, and more preferably has an average thickness h of 200-3000 nm.

Average thickness h of the resin coating layer is a value determined by the following method. That is, a thin specimen of the carrier particle was prepared employing a focused ion beam specimen preparation system (SM12050, manufactured by SII NanoTechnology Inc.), and the cross-section of the thin specimen was subsequently observed in a visual field at a magnification of 5000 times employing a transmission electron microscope (JEM-2010F, manufactured by JEOL Ltd.) A mean value of the maximum layer thickness portion and the minimum layer thickness portion of one carrier in the visual field is first calculated, followed by similar calculation also made for each of 100 carriers, and the mean value obtained via the 100 carriers is designated as average thickness h of the resin coating layer.

### [Method of Forming Resin Coating Layer]

Examples of the method of forming a resin coating layer for such the carrier include a wet coating method and-a dry coating method as described below. Of these, the dry coating method is preferable in view of easy adjustment of an average porosity ratio.

The following methods (1)-(3) can be provided as the wet coating method.

### (1) Fluidized Bed Spray Coating Method:

This method is a method in which a coating solution prepared by dissolving a resin to form a resin coating layer (hereinafter, referred to as “coating resin”) in a solvent is spray-coated onto the surface of the magnetic material particle with a fluidized bed, and a drying process is subsequently conducted to form a coated layer.

### (2) Immersion Coating Method:

This method is a method in which magnetic material particles are immersed in a coating solution prepared by dissolving a coating resin in a solvent to conduct a coating treatment, and a drying process is subsequently conducted to form a coated layer

### (3) Polymerization Method:

This method is a method in which magnetic material particles are immersed in a monomer coating solution prepared by dissolving a polymerizable compound to form a coating resin in a solvent to conduct a coating treatment, and a polymerization treatment is subsequently conducted by applying heat to form a coated layer.

The dry coating method is a method in which particles made of a coating resin are deposited on the surface of the magnetic material particle, and the coating resin particles are subsequently dissolved or softened via application of a mechanical impact force to be firmly fixed on the surface of the magnetic material particle and to prepare a coated layer. Specifically, employing a high-speed stirring mixer, usable for an admixture of magnetic material particles, coating resin particles and conductive particles under the condition of application or non-application of heat, a mechanical impact force is repeatedly applied to the admixture while stirring at high speed, and the coating resin particles are dissolved or softened and firmly fixed on the surface of the magnetic material particle to prepare a coated layer. Charge control particles may be contained in the foregoing admixture. When applying a mechanical impact force under the heat application, a heating temperature of 60-125° C. is preferable. When the heating temperature is too large, coagulation of carrier particle-to-carrier particle is easily generated.

In the dry coating method, porosities can be formed by providing mechanical impact force at a peripheral speed of 7-12 m/sec at a 10-20° C. lower temperature than a glass transition temperature Tg of the coating resin, and the average porosity ratio can be adjusted by controlling a duration to provide the mechanical impact force in the range of 90-120 minutes. The longer the duration to provide the mechanical impact force, the smaller the average porosity ratio is. The longer the duration to provide the mechanical impact force, the smaller the average porosity ratio is, since porosity on the resin coating layer is filled in, that is, the resin coating layer thickness becomes thinner, whereby lower resistivity and the smooth resin coating layer surface are produced, resulting in an advantage such that charge providing performance of a carrier is improved since the resulting carrier exhibits a high fluidity.

### <<Magnetic Material Particle>>

The magnetic material particle constituting a carrier of the present invention is a core particle of the carrier. Examples of such the magnetic material particles include iron particles, magnetite particles and particles made of various kinds of ferrite, or resin-dispersion type particles in which these particles are dispersed in a binder resin of these, magnetite and particles made of each of various kinds of ferrite are preferable. Of various kind of ferrite, preferable are ferrite containing a heavy metal such as copper, zinc, nickel or manganese, and a light metal ferrite containing at least one of an alkali metal and an alkaline earth metal. Further, as a binder resin constituting resin-dispersion type particles are not specifically limited, and any commonly known one is usable. Usable examples thereof include a styrene-acrylic resin, a polyester resin, a fluorine resin, a phenol resin and so forth.

A magnetic material particle preferably has a volume-average particle diameter D4 of 10-100 μm, and more preferably has a volume-average particle diameter D4 of 20-80 μm. The volume-average particle diameter D4 of magnetic material particles are measured by a laser diffraction type particle size distribution analyzer “HELOS” (manufactured by SYMPATEC Co.) equipped with a wet type homogenizer to determine the foregoing volume-based average particle diameter.

As to a magnetization characteristic, it is preferable that the magnetization characteristic of the resulting carrier exhibits a saturation magnetization of 2.5×10⁻⁵-15.0×10⁻⁵ Wb·m/kg. The saturation magnetization is measured employing an automatic recording device for D.C. magnetization characteristic 3257-35 (manufactured by Yokogawa Electric Co., Ltd.). In addition, concerning the measurement condition of saturation magnetization of carrier, as the measured magnetic carrier, employed one previously subjected to a humidity conditioning treatment at 20° C. and 50% RH for 2 hours. The magnetic carrier is filled in an acrylic cylinder having an inner diameter of 15.8 mm to determine packing density ρ. Subsequently, the acrylic cylinder in which the magnetic carrier is filled is set to an automatic direct current magnetization characteristic recording apparatus, and applied to a magnetic field of 10 kOe to obtain a magnetic hysteresis curve in X-axis of magnetic flux density B (Gauss) and Y-axis of magnetic field H (Oe), whereby a value of σ₁₀₀₀ as the saturation magnetization to be used is determined from the resulting magnetic hysteresis curve.

### [Resistance of Carrier]

The carrier of the present invention before use has a resistance of 1×10⁸-3×10¹⁰ Ωcm, and preferably has a resistance of 2×10⁸-1×10¹⁰ Ωcm.

“Carrier resistance” means resistance measured dynamically under the developing condition by a magnetic brush. A photoreceptor drum is replaced by an electrode drum made of aluminum having the same size as the photoreceptor drum to form a magnetic brush by supplying particles onto a developing sleeve, and the electrode drum is rubbed with this magnetic brush. The current flowing between the sleeve and the drum was measured after applying voltage (500 V) between them to determine the carrier resistance by introducing this measured value I into the following formula (1).

Carrier resistance DVR (106 cm)=(V/I)×(N×L/Dsd) Formula (1)

In the above-described Formula (1),
V: Voltage between a developing sleeve and a drum (V)
I. Measured current (A)
N: Developing nip width (cm)
L: Developing sleeve length (cm)
and
Dsd: Distance between a developing sleeve and a drum (cm), provided that in the present invention, measurements are carried out with V=500 V, N=1 cm, L=6 cm, and Dsd=0.06 cm.

### [Particle Diameter of Carrier]

The carrier of the present invention preferably has a volume-average particle diameter D4 of 10-100 μm, and more preferably has a volume-average particle diameter D4 of 20-80 μm. The volume-average particle diameter D4 of this carrier can be measured by a laser diffraction type particle size distribution analyzer “HELOS” (manufactured by SYMPATEC Co.) equipped with a wet type homogenizer.

### [Developer]

The carrier as described above is mixed with toner to form a developer. The toner preferably has a particle diameter of 3-8 μm in terms of volume-based median diameter (D₅₀), and more preferably 4-7 μm.

The volume-based median diameter of the toner is measured and calculated by a measuring apparatus in which a data processing computer system (manufactured by Beckman Coulter Inc.) is connected to “COULTER MULTISIZER TA-III” (manufactured by Beckman Coulter Inc.). Specifically, after adding 0.02 g of the toner as a measured specimen into 20 ml. Of a surfactant solution (a surfactant solution obtained by diluting a neutral detergent containing a surfactant component by 10 times with water, for the purpose of dispersion of the measured specimen, for example) to prepare the specimen dispersion via ultrasonic dispersion for one minute, this specimen dispersion is charged into a beaker containing “TSOTON II” (manufactured by Beckman Coulter Inc.) set inside a sample stand by a pipette until concentration displayed by the measuring apparatus reaches 8%. The reproducible measured value can be obtained by setting to this concentration. The count number of measured particles and the aperture diameter are set to 25,000 and 50 μm with the measuring apparatus, respectively, the frequency value is calculated by dividing the measurement range of 1-30 μm into 256 divisions. The 50% particle diameter obtained from the larger side of the cumulative volume percent is defined as the volume-based median diameter.

### [Image Forming Method]

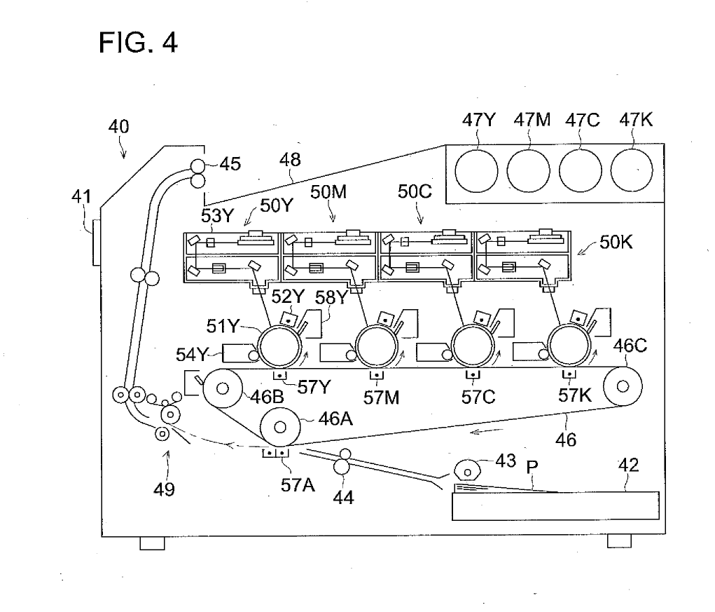

The developer containing an electrophotographic carrier of the present invention can be preferably utilized for an image forming method via electrophotography. FIG. 4 is a schematic diagram showing a structural example of an image forming apparatus in which a developer formed from a carrier of the present invention is employed. This image forming apparatus 40 is a tandem type color image forming apparatus, and equipped with a plurality of image forming units 50Y, 50C and 50K, paper feeding cassette 42 and fixing device 49. In FIG. 4, numeral 41 is designated as an operation section, and numerals 47Y, 47M, 47C and 47K are toner cartridges for each color.

Image forming unit 50Y forms a yellow toner image, equipped with photoreceptor 51 possessing charging device 52Y, exposure device 53Y, developing device 54Y, primary transfer device 57Y, cleaning device 58Y which are provided around this photoreceptor 51Y.

Image forming units 50M, 50C and 50K each possess the same structure as that of image forming unit 50y, except that Image forming units 50M, 50C and 50K form a magenta toner image, a cyan toner image and a black toner image, respectively, in place of the yellow toner image, wherein the yellow toner image is formed with image forming unit 50Y, the magenta toner image is formed with image forming unit 50M, the cyan toner image is formed with image forming unit 50C, and the black toner image is formed with image forming unit 50K.

Intermediate transfer member 46 is hitched to a plurality of supporting rollers 46A, 46B and 46C, and supported in a circularly movable manner.

Such the image forming apparatus forms images as described below. That is, each of color toner images formed by image forming units 50Y, 50M, 50C and 50K is primarily transferred onto circularly movable intermediate transfer member 46 by each of primary transfer devices 57Y, 57M, 57C and 57K, and is superimposed to form a color toner image. On the other hand, image support P stored in paper feeding cassette 42 is fed sheet by sheet by paper-feeding roller 43, and conveyed to secondary transfer device 57A by resist roller 44 to transfer the color toner image onto image support P. Next, image support P is conveyed to fixing device 49 to conduct a fixing treatment, and subsequently nipped by paper eject rollers 45 to eject image support P, by which the fixed image is carried, onto paper eject tray 48 outside the apparatus.

According to the carrier described above, a conduction path is acquired with a small amount of conductive particles by which no influence is produced with respect to charge providing performance since the resin coating layer possesses a specific capacity of porosity. Accordingly, low resistivity is generated by this, and appropriate action is given as a developing electrode while exhibiting excellent charge providing performance for a long duration. As a result, an edge effect is suppressed for a long period of time, and high fine line reproduction is obtained to form high-quality images.

### EXAMPLE

Next, specific examples of the present invention will be described, but the present invention is not limited thereto.

### Carrier Preparation Example 1

Into a high-speed mixer equipped with stirring blades, charged were 1100 parts by weight of Mn—Mg ferrite particles having a volume-average particle diameter D4 of 60 μm and a saturation magnetization of 10.7×10⁻⁵ Wb·m/kg, and 3.8 parts by weight of resin particles made of a styrene/methylmethacrylate copolymer having a copolymerization ratio of 2/8 and a glass transition temperature Tg of 130° C., and 0.57 parts by weight of carbon black having a particle diameter of 30 nm, and a resin coating layer was formed on the ferrite core particle surface via action of mechanical impact force to obtain carrier [1]. In carrier [1] the resin coating layer has an average thickness h of 2,400 nm. The average porosity ratio of carrier [1] was also measured with the method described above. The results are shown in Table 1.

### Carrier Preparation Examples 2-7

Carriers [2]-[7] were acquired similarly to carrier preparation example 1, except that kinds of resin to form the resin coating layer and dry coating time are changed as shown in Table 1. Average porosity ratios of these carriers [2]-[7] are shown in Table 1.

### [Black Toner Preparation Example]

### (1) Preparation of Composite Colorant Particle

Under the condition of a linear weight of 441 N/cm (45 kg/cm) for 10 hours employing an edge runner type mill (manufactured by Matsumoto Tekkosho Co., Ltd), mixed were 100 parts by weight of the product obtained by 10% treating tetraoctyl titanate with silica particles “AEROSIL200” produced by Nihon Aerosil Co., Ltd., and 110 parts by weight of carbon black “MA100” for coating produced by Mitsubishi chemical corporation to prepare composite colorant particle [1]. In addition, the above-described silica particle herein is fumed silica fumed silica having an average primary particle diameter, a BET specific surface area of 200 g/m², and a density of 50 g/liter, which has not been subjected to a hydrophobization treatment.

### (2) Preparation of Resin Particle for Toner

### (2-1) Preparation of Latex [1HML]

### (2-1-1) Preparation of Latex [1H]: Preparation of Nucleus Particle (The First Step Polymerization)

Into a separable flask of 5 liters fitted with a stirring device, a temperature sensor, a cooling tube and a nitrogen introducing device, charged was a surfactant solution in which 7.08 g of an anionic surfactant represented by the following formula (X) were dissolved in 3010 g of deionized water, and the internal temperature was raised to 80° C. while stirring at a stirring speed of 230 rpm under nitrogen flow. After an initiator solution, in which 9.2 g of a polymerizable initiator (potassium peroxodisulfate: KPS) were dissolved in 200 g of deionized water, was added into this surfactant solution, and the temperature was set to 75° C., a monomer mixture solution containing 70.1 g of styrene, 19.9 g of n-butylacrylate, and 10.9 g of methacrylic acid was. dripped for one hour, polymerization (the first step polymerization) was conducted while heating this system at 75° C. for two hours, and stirring to prepare latex (dispersion of resin particles made of a high molecular weight resin)

C₁₀H₂₁(OCH₂CH₂)₂OSO₃Na Formula (X)

### (2-1-2) Preparation of Latex [1HM]: Formation of Intermediate Layer (The Second Step Polymerization)

Into a monomer mixture solution containing 105.6 g of styrene, 30.0 g of n-butylacrylate, 6.2.g of methacrylic acid and 5.6 g of n-octyl-3-mercaptopropionate ester, added was 98.0 g of a crystalline compound represented by the following Formula (W), in a flask fitted with a stirring device, and temperature was raised up to 90° C. for dissolution to prepare a monomer solution. On the other hand, after a surfactant solution, in which 1.6 g of an anionic surfactant represented by above-described Formula (X) were dissolved in 2700 g of deionized water, was heated to 98° C., and 28 g (in terms of solid content conversion) of the foregoing latex [1H] as a nucleus particle dispersion was added into this surfactant solutions a monomer solution of the foregoing crystalline compound was mixed and dispersed for 8 hours employing a mechanical homogenizer CLTARMIX (manufactured by M-Technique Co., Ltd.) having a circulation path. Next, an initiator solution in which 5.1 g of polymerizable initiator (KPS) were dissolved in 240 g of deionized water and 750 g of deionized water were added into this emulsified liquid, and polymerization (the second %tep polymerization) was conducted via heating of this system at 98° C. for 12 hours while stirring to obtain latex (dispersion of composite resin particles each having a structure in which the surface of a resin particle made of a high molecular resin was coated with a medium molecular resin) [1HM].

C{CCH₂OCO(CH₂)₂₀CH₃}₄ Formula (W)

### (2-1-3) Preparation of Latex [1HML]: Formation of External Layer (the Third Step Polymerization)

An initiator solution, in which 7.4 g of a polymerization initiator (KPS) were dissolved in 200 g of deionized water, into latex [1HM] obtained as described above, and a monomer mixture solution containing 300 g of styrene, 95 g of n-butylacrylate, 15.3 g of a methacrylic acid and 10.4 g of n-octyl-3-mercaptopropionate ester was dripped for one hour. After dripping, heating while stirring was conducted for 2 hours to conduct polymerization (the third step polymerization), and the system was subsequently cooled down to 28° C. to obtain latex (dispersion of composite resin particles composed of a central portion made of a high molecular weight resin, an intermediate layer made of a medium molecular weight resin, and an external layer made of a low molecular weight resin, wherein the foregoing intermediate layer contains a crystalline compound) [1HML].

The composite resin particle constituting this latex [1HML] has a peal molecular weight of 138000, 80000 and 13000, and the composite resin particles have a weight average particle diameter of 122 nm. In addition, particle diameters of these resin particles are measured by MICROTRAC UPA-150, manufactured by HONEYWELL, and are treated as the volume-average particle diameter.

### (2-2) Preparation of Latex [2L]

An initiator solution, in which 14.8 g of a polymerizable initiator [KPS] were dissolved in 400 g of deionized water, was charged in a flask equipped with a stirring device, and a monomer mixture solution containing 600 g of styrene, 190 g of n-butylacrylate, 30.0 g of a methacrylic acid and 20.8 g of n-octyl-3-mercaptopropionate ester was dripped at 80° C. for one hour. After dripping, heating while stirring was conducted for 2 hours to conduct polymerization, and the system was subsequently cooled down to 27° C. to obtain latex (dispersion of resin particles made of a low molecular weight resin) [2L].

This resin particle constituting this latex [2L] has a peal molecular weight of 11000, and the resin particles have a weight average particle diameter of 128 nm.

### (3) Preparation of Electrophotographic Black Toner

In 1600 g of deionized water, dissolved were 59.0 g of an anionic surfactant while stirring, 320.0 q of composite colorant particles [1] were gradually added while stirring this solution, and a dispersion treatment was conducted employing a stirring device (CLEARMIX, manufactured by M-Technique Co., Ltd.) to prepare a dispersion of colorant particles [1].

Into a reaction vessel (four neck flask) fitted with a stirring device, a temperature sensor, a cooling tube and a nitrogen introducing device, charged were 420.7 g of latex (in terms of solid content conversion) [1HML], 900 g of deionized water, and 200 g of a composite colorant particle dispersion [1] while stirring. After adjusting temperature inside the vessel to 30° C., 5 mol/liter of an aqueous sodium hydroxide solution was added into this solution to adjust pH to 8.5-11.0.

Next, an aqueous solution in which 12.1 g of magnesium chloride hexahydrate were dissolved in 1000 g of deionized water was added at 30° C. for 10 minutes while stirring. After standing for three minutes, this system was heated to 90° C. spending 60 minutes. In such the state, the particle diameter of associated particles was measured employing “Coulter Counter TA-II”. When the number average particle diameter reached 6-5 μm, an aqueous solution in which 40.2 g of sodium chloride were dissolved in 100.0 g of deionized water was added to stop particle growth, and heating while stirring was further conducted as a ripening treatment at a liquid temperature of 98° C. for 6 hours to continue fusion.

Further, 96 g of latex [2L] were added, and heating while stirring was continued for 3 hours to fuse latex [2L] on the surface of coagulated particles [1HML]. Herein, 40.2 g of sodium chloride was added, the system was cooled down to 30° C. at a rate of 8° C./min to adjust pH to 2.0 via addition of a hydrochloric acid, and stirring was terminated. The resulting salting-out and coagulated particles were filtrated, washed repeatedly with deionized water, and then dried in warm air at 40° C. to obtain black particles.

Into the resulting black particles, added were 0.8 parts by weight of hydrophobic silica having a number average primary particle diameter of 35 nm and 1.0 parts by weight of hydrophobic titanium oxide having an average primary particle diameter of 25 nm, and the system was mixed for 25 minutes employing a 101 HENSCHEL Mixer with a circulation speed of a rotational stirring blade of 30 m/sec to obtain black toner. This black toner had a volume-based median diameter of 6.5 μm.

In addition, the volume-based median diameter of toner was measured as described below.

That is, the volume-based median diameter is measured and calculated by a measuring apparatus in which a data processing computer system (manufactured by Beckman Coulter Inc.) is connected to “Coulter Multisizer TA-III” (manufactured by Beckman Coulter Inc.) Specifically, after adding 0.02 g of the toner into 20 ml of a surtactant solution (a surtactant solution obtained by diluting a neutral detergent containing a surfactant component by 10 times with water, for the purpose of dispersion of toner, for example) to prepare the specimen dispersion via ultrasonic dispersion for one minute, this toner dispersion is charged into a beaker containing “ISOTON II” (manufactured by Beckman Coulter Inc.) set inside a sample stand by a pipette until concentration displayed by the measuring apparatus reaches 5-10%. The reproducible measured value can be obtained by setting to this concentration. The count number of measured particles and the aperture diameter are set to 25,000 and 50 Am with the measuring apparatus, respectively, the frequency value is calculated by dividing the measurement range of 1-30 μm into 256 divisions. The 50% particle diameter obtained from the larger side of the cumulative volume percent is defined as the volume-based median diameter.

### Developer Preparation Examples 1-7

Hundred parts by weight of the above-described carriers [1]-[4] and comparative carriers [5]-[7] each, and 6 parts by weight of the above-described black toner were mixed with a V type mixer to prepare developers [1]-[4] and comparative developers [5]-[7].

### Examples 1-4 and Comparative Examples 1-3

Image evaluation of the edge effect generation level, generation of fog, and fine line reproduction was conducted with the above-described developers [1]-[4] and comparative developers [5]-[7]. As to the edge effect generation level and generation of fog, a divided test image having a pixel ratio of 10% (an image formed by allocating four equal quarters for each of a text image having a pixel ratio of 7%, a portrait, a solid white image, and a solid black image) was output on a A4 size fine-quality paper sheet (64 g/m²) with the above-described developer, employing a remodeled copier of a commercially available machine “bizhub Pro C500” manufactured by Konica Minolta Business Technologies, Inc. to evaluate divided test images at an initial stage and after outputting 500.000 prints The results are shown in Table 1.

### (1) Edge Effect

The image density difference between in a central portion and in an end portion in a solid black image of the output divided test image was visually observed, and evaluated as described below. Ranks A-C exhibit no problem in practical use.

A: No density difference is observed.

B: Density difference is slightly observed.

C: Density difference is observed, but is in the tolerable range.

D: Density difference is observed, and is not in the tolerable range.

### (2) Generation of Fog

The image density of not printed white paper of the above-described fine-quality paper sheet was measured at 20 points employing a reflection densitometer “RD-918” (manufactured by Macbeth Co.), and the mean value was specified as the white paper density. Next, the density of the solid white image portion of an output divided test image was similarly measured at 20 points, and the value obtained via subtraction of the above-described white paper density from this mean value was obtained as fog density to be evaluated in the following criteria. In the case of a fog density of less than 0.010, generation of fog exhibits no problem in practical use.

A: A fog density of less than 0.003

B: A fog density of at least 0.003 and less than 0.006

C: A fog density of at least 0.006 and less than 0.010

D: A fog density of 0.010 or more

### (3) Fine Line Reproduction

The test line image corresponding to a 2 dot line image signal was formed for 2000 prints employing A4 size fine-quality paper (64 g/m²) and a remodeled copier of a commercially available machine “bizhub Pro C500” manufactured by Konica Minolta Business Technologies, Inc for which a print image electrophotographic system was utilized. Line width (W₁) in the 1^{st} print test line image and line width (W₂) in the 20,000^{th} print test line image each were measured with a printing evaluation system RT2000 (manufactured by YA-MAN, Inc). Criteria were given as “Pass” and “Fail” described below.

“Pass” when any of W₁ and W₂ is 200 μm or less, and (W₂−W₁) is less than 10 μm.

“Fail” when (W₂−W₁) is 10 μm or more.

“Pass” evaluated above exhibits no problem in practical use.

TABLE 1

| | | | | | Evaluated results | | | | |
|---|---|---|---|---|---|---|---|---|---|
| | | | | | Edge | | Generation | | |
| | | | Dry | | effect | | of fog | | |
| | | | coating | | At | | At | | Fine |
| | Carrier | | time | Porosity | initial | | initial | | line |
| | No. | Coated resin | (min) | ratio (%) | stage | *1 | stage | *1 | reproduction |
| Example 1 | [1] | Styrene/methylmethacrylate resin | 120 | 1 | A | A | A | A | Pass |
| Example 2 | [2] | Styrene/methylmethacrylate resin | 110 | 5 | A | A | A | A | Pass |
| Example 3 | [3] | Styrene/methylmethacrylate resin | 95 | 10 | A | B | A | B | Pass |
| Example 4 | [4] | Styrene/methylmethacrylate resin | 90 | 20 | A | B | A | B | Pass |
| Comp. 1 | [5] | Styrene/methylmethacrylate resin | 10 | 30 | C | D | C | D | Fail |
| Comp. 2 | [6] | Styrene/methylmethacrylate resin | 180 | 0.8 | A | D | B | B | Pass |
| Comp. 3 | [7] | Silicone resin | — | 0 | B | D | B | C | Pass |

*1: After outputting 500,000 prints,
Comp.: Comparative example

As described above, it was confirmed that an edge effect was inhibited by using each of developers [1]-[4] formed from each of carriers of Examples 1-4 of the present invention, generation of fog was lowered, and high fine line reproduction was obtained.

### EFFECT OF THE INVENTION

In the case of an electrophotographic carrier of the present invention, a conductive path is acquired through a small amount of conductive particles showing little impact on charge providing performance, since a specific volume of porosity is occupied in a resin coating layer, whereby low resistivity is obtained. Accordingly, the electrophotographic carrier delivers appropriate action as a developing electrode while accepting excellent charge providing performance for a long duration, so that an edge effect is inhibited for a long duration, and a high-quality image exhibiting high fine line reproduction can be formed.

The reason why a conductive path is acquired through a small amount of conductive particles showing little impact on charge providing performance by possessing a certain amount of porosity in a resin coating layer of the carrier has not yet been clear, but the following phenomenon (1) or (2) is presumably produced.

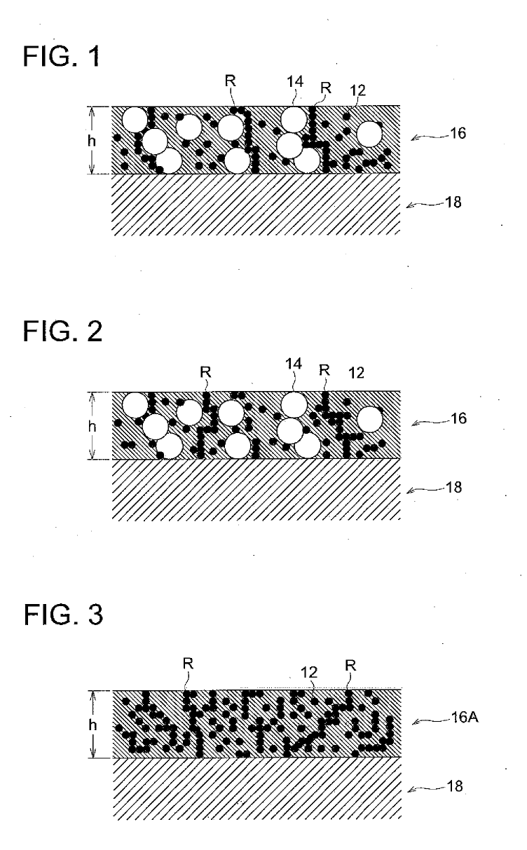

(1): As shown in FIG. 1, conductive particles 12 are situated along the peripheral portion of porosities 14, and conductive particles 12 are continuously brought into contact with each other, whereby conductive path R is formed as a shape along the shape of porosities 14.

(2): As shown in FIG. 2, the existing region of conductive particles 12 in resin coating layer 16 is limited because of the existence of porosities 14, whereby high contact probability is produced via approaching of conductive particle 12-to-conductive particle 12 to form conductive path R.

On the other hand, as shown in FIG. 3, in order to design a resin coating layer possessing no porosity (hereinafter, referred to also as “conventional resin coating layer”) 16A having the same low resistivity as that of a resin coating layer possessing porosity 14 (hereinafter, referred to also as “resin coating layer of the present invention”) 16, the same number of conductive paths R as that of conductive paths R in resin coating layer 16 of the present invention has to be formed in conventional resin coating layer 16A, but as a result, sufficient charge providing performance can not be obtained, since in order to achieve the above described, a larger amount of conductive particle 12 than that of one contained in resin coating layer 16 of the present invention is desired to be contained. In addition, the content of conductive particle 12 is to be increased with thickness of conventional resin coating layer 16A being thicker in order to achieve low resistivity, resulting in lower electrification with the thicker thickness.

As described above, low resistivity of the carrier is presumably achieved with a small amount of conductive particle 12 showing little impact on charge providing performance, since the presence of porosities 14 reduces conductive particle 12 making little contribution to formation of conductive path R in resin coating layer 16 of the present invention. Incidentally, numeral 18 represents a magnetic material particle in the figures.

What is claimed is:

1. An electrophotographic carrier comprising a magnetic material particle, and a resin coating layer provided on a surface of the magnetic material particle, the resin coating layer comprising conductive particles,
wherein a cross section of the resin coating layer has an average porosity ratio of 1-20%.

2. The electrophotographic carrier of claim 1,
wherein the resin coating layer comprises an acrylic resin.

3. The electrophotographic carrier of claim 1,
wherein the average porosity ratio is 1-5%.

4. The electrophotographic carrier of claim 2,
wherein the acrylic resin comprises at least one of a polyacrylic acid, a polymethacrylic acid, polymethyl acrylate; polymethyl methacrylate and polycyclohexyl methacrylate.

5. The electrophotographic carrier of claim 1,
wherein the conductive particles contain at least one of carbon black, zinc oxide and tin oxide.

6. The electrophotographic carrier of claim 1,
wherein the conductive particles have a number average primary particle diameter of 5-150 nm.

7. The electrophotographic carrier of claim 1,
wherein an addition amount of the conductive particles in the resin coating layer is 2-40 parts by weight, with respect to 100 parts by weight of a resin constituting the resin coating layer, provided that the conductive particles consist of carbon black.

8. The electrophotographic carrier of claim 1,
wherein an addition amount of the conductive particles in the resin coating layer is 2-150 parts by weight, with respect to 100 parts by weight of a resin constituting the resin coating layer, provided that the conductive particles consist of zinc oxide.

9. The electrophotographic carrier of claim 1,
wherein an addition amount of the conductive particles in the resin coating layer is 2-200 parts by weight, with respect to 100 parts by weight of a resin constituting the resin coating layer, provided that the conductive particles consist of tin oxide.

10. The electrophotographic carrier of claim 1,
wherein a resin constituting the resin coating layer has a glass transition temperature Tg of 110-180° C.

11. The electrophotographic carrier of claim 1,
wherein the resin coating layer has an average thickness of 50-4000 nm.

12. The electrophotographic carrier of claim 11,
wherein the average thickness is 200-3000 nm.

13. The electrophotographic carrier of claim 1, wherein the resin coating layer is provided on the magnetic material particle by a dry coating method.

14. The electrophotographic carrier of claim 1,
wherein the magnetic material particle comprises iron, magnetite or ferrite.

15. The electrophotographic carrier of claim 1, comprising the magnetic material particle having a saturation magnetization of 2.5×10⁻⁵-15.0×10⁻⁵ Wb·m/kg.

16. The electrophotographic carrier of claim 1,
wherein the carrier before use has a resistance of 1×10⁸-3×10¹⁰ Ωcm.

17. The electrophotographic carrier of claim 16,
wherein the resistance is 2×10⁸-1×10¹⁰ Ωcm.

18. The electrophotographic carrier of claim 1, having a volume-average particle diameter D4 of 10-100 μm.
